(19) United States
(12) Patent Application Publication
(10) Pub. No.: US 2021/0124743 A1
(43) Pub. Date: Apr. 29, 2021

(54) Server and a Computer Program Building a Join Tree

(71) Applicant: TmaxData Co., Ltd., Gyeonggi-do (KR)

(72) Inventors: SeongGyu CHOI, Gyeonggi-do (KR); YongHwa KIM, Gyeonggi-do (KR); Jea Gon PARK, Seoul (KR); Jimin PARK, Gyeonggi-do (KR); Kyungtae SONG, Gyeonggi-do (KR)

(21) Appl. No.: 16/665,605

(22) Filed: Oct. 28, 2019

(30) Foreign Application Priority Data
Oct. 28, 2019 (KR) 10-2019-0134208

(51) Int. Cl. G06F 16/2453; G06F 16/22

(52) U.S. Cl. CPC G06F 16/24544; G06F 16/2246

(57) ABSTRACT

Disclosed is a computer program stored in a computer readable storage medium including commands which cause a computer program to execute operations and the operations include: receiving a query including a join operation; recognizing at least one join predicate by analyzing the query; generating at least two join predicate groups using tables associated with each of the at least one join predicate; generating join trees by combining each of the at least two join predicate groups in a different order; calculating a cost of each of the join trees; and recognizing a join tree having the smallest cost among the join trees.

### CROSS-REFERENCE TO RELATED APPLICATIONS

This application claims priority to and the benefit of Korean Patent Application No. 10-2019-0134208 filed in the Korean Intellectual Property Office on Oct. 28, 2019, the entire contents of which are incorporated herein by reference.

### TECHNICAL FIELD

The present disclosure relates to a join building technique and a database server.

### BACKGROUND ART

Businesses of enterprises are rapidly expanding with explosive data growth and the emergence of diverse environments and platforms. As new business environments emerge, more efficient and flexible data services and information processing, and data management functions are needed. In response to these changes, a research is continued on databases to solve problems of high performance, high availability, and scalability which are foundations of corporate business implementation.

In a database management system (DBMS), data may be stored in a data storage. In a relational database management system (RDBMS), the data storage may be referred to as a table. The table may include one or more rows and each of the one or more rows may include one or more columns.

When the database includes a large amount of data, it may take a relatively long time to process a query to perform a join operation on a plurality of data received from a user. When it takes a long time for the database to respond to the query, it may adversely affect performance of the database.

A plurality of execution algorithms (alternatively, plans) may be considered in connection with a manner in which the query issued from client is processed. Since the respective execution algorithms have different properties, it is necessary to determine an algorithm most suitable for processing the corresponding query before processing the corresponding query.

In particular, based on the query including the join operation, a speed for processing the query may vary depending on by which method tables are joined at the time of performing the join operation. Accordingly, there is a need in the art for more efficiently creating an optimized execution plan for processing the query.

### SUMMARY OF THE INVENTION

The present disclosure has been made in an effort to provide a computer program and a server executing a join operation by an optimized execution plan.

However, technical objects of the present disclosure are not restricted to the technical object mentioned as above. Unmentioned technical objects will be apparently appreciated by those skilled in the art by referencing to the following description.

An exemplary embodiment of the present disclosure provides a computer readable medium containing a computer program. The computer program stored in a computer readable storage medium may include commands which cause a computer to execute operations and the operations may include: receiving a query including a join operation; recognizing at least one join predicate by analyzing the query; generating at least two join predicate group using tables associated with each of the at least one join predicates; generating join trees by combining each of the at least two join predicate groups in a different order; calculating a cost of each of the join trees; and recognizing a join tree having the smallest cost among the join trees.

Further, the generating of at least one join predicate group using tables associated with each of the at least two join predicates may include: if the at least one join predicate includes a first join predicate and a second join predicate, generating a first join predicate group using a first table group associated with the first join predicate, and generating a second join predicate group using a second table group associated with the second join predicate.

Further, the generating of join trees by combining each of the at least two join predicate groups in a different order may include: joining each of the first table group to generate a first subtree, and then joining each of the second table group to generate a second subtree; and joining the first subtree to the second subtree to generate a first join tree.

Further, the generating of join trees by combining each of the at least two join predicate groups in a different order may include: joining each of the second table group to generate a second subtree before joining each of the first table group to generate a first subtree; and joining the each of the first table group to the second subtree to generate a second join tree.

Further, the generating of join trees by combining each of the at least two join predicate groups in a different order may further include: recognizing cardinality values of each of the first join predicate group and the second join predicate group using a first value which is multiplied by a number of rows of the each of the first table group, a second value which is multiplied by a number of rows of the each of the second table group, a first join selectivity associated with the first table group, and a second join selectivity associated with the second table group; and determining a subtree to be generated first among the first subtree and the second subtree according to a first cardinality value of the first join predicate group and a second cardinality value of the second join predicate group.

Further, the determining of a subtree to be generated first among the first subtree and the second subtree may include: if it is recognized that the first cardinality value is lower than the second cardinality, determining the first subtree as the subtree to be generated first; and if the first subtree is determined as the subtree to be generated first, generating the first subtree before generating the second subtree.

Further, the determining of a subtree to be generated first among the first subtree and the second subtree may include: if it is recognized that the first cardinality is higher than the second cardinality, determining the second subtree as the subtree to be generated first; and if the second subtree is determined as the subtree to be generated first, generating the second subtree before generating the first subtree.

Further, the generating of join trees by combining each of the at least two join predicate groups in a different order may further include: determining a priority of each of the first join predicate and a third join predicate; and determining a subtree to be generated first among the first subtree and a third subtree according to a first priority of the first join predicate and a second priority of the third join predicate.

Further, the determining of a subtree to be generated first among the first subtree and the third subtree according to the priorities of the first join predicate and the third join predicate for each of the two join predicate groups may include: if it is recognized that the first priority is lower than the second priority, determining the third subtree as the subtree to be generated first.

Further, the determining of a subtree to be generated first among the first subtree and a third subtree according to the priorities of the first join predicate and the third join predicate for each of the two join predicate groups may include: if the first priority is higher than the second priority, determining the first subtree as the subtree to be generated first.

Further, the generating of join trees by combining each of the at least two join predicate groups in a different order may include: when generating an Nth join tree, recognizing a first cost of a join tree having the smallest cost among join trees up to an N−1th join tree; calculating a second cost of a first sub join tree combining each of M(M is a natural number) join predicate groups; and calculating a second cost of a first sub join tree combining each of M(M is a natural number) join predicate groups; and if the second cost is bigger than the first cost, using a second sub join tree except the first sub join tree when generating the Nth join tree and a join tree after the Nth join tree.

Further, the generating of join trees by combining each of the at least two join predicate groups in a different order may further include: checking joined tables and non-joined tables; if at least one table included in the non-joined tables exists among the joined tables, checking a first time point at which the at least one table is joined; and recognizing that the at least one table is joined at the first time point.

Further, another exemplary embodiment of the present disclosure provides a database server including: a communication unit receiving a query including a join operation; and a processor recognizing at least one join predicate by analyzing the query; in which the processor is further configured to: generate at least two join predicate groups using tables associated with each of the at least one join predicate, generate join trees by combining each of the at least two join predicate groups in a different order, calculate a cost of each of the join trees, and recognize a join tree having the smallest cost among the join trees.

Further, the processor may be further configured to: if the at least one join predicate includes a first join predicate and a second join predicate, generate a first join predicate group using a first table group associated with the first join predicate, and generate a second join predicate group using a second table group associated with the second join predicate, join each of the first table group to generate a first subtree, and then join each of the second table group to generate a second subtree, and join the first subtree to the second subtree to generate a first join tree.

Further, the processor may be further configured to: if the at least one join predicate includes a first join predicate and a second join predicate, generate a first join predicate group using a first table group associated with the first join predicate, and generate a second join predicate group using a second table group associated with the second join predicate, join each of the second table group to generate a second subtree before joining each of the first table group to generate a first subtree, and join the each of the first table group to the second subtree to generate a second join tree.

Further, the processor may be further configured to: recognize cardinality values of each of the first join predicate group and the second join predicate group using a first value which is multiplied by a number of rows of the each of the first table group, a second value which is multiplied by a number of rows of the each of the second table group, a first join selectivity associated with the first table group, and a second join selectivity associated with the second table group, if a first cardinality value of the first join predicate group is lower than a second cardinality value of the second join predicate group, generate the second subtree after generating the first subtree, and if the first cardinality value of the first join predicate group is higher than the second cardinality value of the second join predicate group, generate the first subtree after generating the second subtree.

Further, the processor may be further configured to: determine a priority of each of the first join predicate and a third join predicate, and determine a subtree to be generated first among the first subtree and a third subtree according to a first priority of the first join predicate and a second priority of the third join predicate.

Further, the processor may be further configured to: when generating an Nth join tree, recognize a first cost of a join tree having the smallest cost among join trees up to an N−1th join tree, calculate a second cost of a first sub join tree combining each of M(M is a natural number) join predicate groups, and if the second cost is bigger than the first cost, use a second sub join tree except the first sub join tree when generating the Nth join tree and a join tree after the Nth join tree.

Further, the processor may be further configured to: when generating join trees by combining the each of the at least two join predicate groups in a different order, check joined tables and non-joined tables, if at least one table included in the non-joined tables exists among the joined tables, check a first time point at which the at least one table is joined, and recognize that the at least one table is joined at the first time point.

Technical solving means which can be obtained in the present disclosure are not limited to the aforementioned solving means and other unmentioned solving means will be clearly understood by those skilled in the art from the following description.

According to exemplary embodiments of the present disclosure, by a computer program and a server, a processing speed for executing a join operation can be enhanced.

Effects which can be obtained in the present disclosure are not limited to the aforementioned effects and other unmentioned effects will be clearly understood by those skilled in the art from the following description.

### BRIEF DESCRIPTION OF THE DRAWINGS

Various aspects are now described with reference to the drawings and like reference numerals are generally used to designate like elements. In the following exemplary embodiments, for the purpose of description, multiple specific detailed matters are presented to provide general understanding of one or more aspects. However, it will be apparent that the aspect(s) can be executed without the specific detailed matters. In other examples, known structures and apparatuses are illustrated in a block diagram form in order to facilitate description of the one or more aspects.

FIG. 1 is a schematic view of an exemplary system including a database server and a client according to some exemplary embodiments of the present disclosure.

FIG. 2 is a diagram for describing an example of a join predicate according to some exemplary embodiments of the present disclosure.

FIG. 3 is a flowchart for describing an example of a method for selecting an optimal join tree by a processor according to some exemplary embodiments of the present disclosure.

FIG. 4 is a flowchart for describing an example of a method for generating at least one join tree by using a subtree by a processor according to some exemplary embodiments of the present disclosure.

FIG. 5 is a diagram for describing an example of a method for recognizing a join tree having smallest cost among join trees by a processor according to some exemplary embodiments of the present disclosure.

FIG. 6 is a flowchart for describing an example of a method for determining a priority of a join tree to be generated at the time of generating the join tree by a processor according to some exemplary embodiments of the present disclosure.

FIG. 7 is a flowchart for describing an example of a method for checking a joined table group and a non-joined table group by a processor according to some exemplary embodiments of the present disclosure.

FIG. 8 is a diagram for describing an example of a method for checking a joined table group and a non-joined table group by a processor according to some exemplary embodiments of the present disclosure.

FIG. 9 is a flowchart for describing an example of a method for determining a join tree to be first generated by a processor according to some exemplary embodiments of the present disclosure.

FIG. 10 is a table for describing an example of a method for determining a join tree to be first generated by a processor according to some exemplary embodiments of the present disclosure.

FIG. 11 is a flowchart for describing an example of a method for generating at least one join tree by a processor according to some exemplary embodiments of the present disclosure.

FIG. 12 is a table for describing an example of a method for generating at least one join tree by a processor according to some exemplary embodiments of the present disclosure.

FIG. 13 is a general schematic view of an exemplary computing environment in which exemplary embodiments of the present disclosure may be implemented.

### DETAILED DESCRIPTION

Various embodiments and/or aspects will be now disclosed with reference to drawings. In the following description, for the purpose of a description, multiple detailed matters will be disclosed in order to help comprehensive appreciation of one or more aspects. However, those skilled in the art of the present disclosure will recognize that the aspect(s) can be executed without the detailed matters. In the following disclosure and the accompanying drawings, specific exemplary aspects of one or more aspects will be described in detail. However, the aspects are exemplary and some of various methods in principles of various aspects may be used and the descriptions are intended to include all of the aspects and equivalents thereof. Specifically, in “embodiment”, “example”, “aspect”, “illustration”, and the like used in the specification, it may not be construed that a predetermined aspect or design which is described is more excellent or advantageous than other aspects or designs.

Hereinafter, like reference numerals refer to like or similar elements regardless of reference numerals and a duplicated description thereof will be omitted. Further, in describing an exemplary embodiment disclosed in the present disclosure, a detailed description of related known technologies will be omitted if it is determined that the detailed description makes the gist of the exemplary embodiment of the present disclosure unclear. Further, the accompanying drawings are only for easily understanding the exemplary embodiment disclosed in this specification and the technical spirit disclosed by this specification is not limited by the accompanying drawings.

Although the terms “first”, “second”, and the like are used for describing various elements or components, these elements or components are not confined by these terms, of course. These terms are merely used for distinguishing one element or component from another element or component. Therefore, a first element or component to be mentioned below may be a second element or component in a technical spirit of the present disclosure.

Unless otherwise defined, all terms (including technical and scientific terms) used in the present specification may be used as the meaning which may be commonly understood by the person with ordinary skill in the art, to which the present disclosure pertains. Terms defined in commonly used dictionaries should not be interpreted in an idealized or excessive sense unless expressly and specifically defined.

Moreover, the term “or” is intended to mean not exclusive “or” but inclusive “or”. That is, when not separately specified or not clear in terms of a context, a sentence “X uses A or B” is intended to mean one of the natural inclusive substitutions. That is, the sentence “X uses A or B” may be applied to all of the case where X uses A, the case where X uses B, or the case where X uses both A and B. Further, it should be understood that the term “and/or” used in the specification designates and includes all available combinations of one or more items among enumerated related items.

In addition, the word “comprises” and/or “comprising” means that the corresponding feature and/or component is present, but it should be appreciated that presence or addition of one or more other features, components, and/or a group thereof is not excluded. Further, when not separately specified or not clear in terms of the context that a singular form is indicated, it should be construed that the singular form generally means “one or more” in the present specification and the claims.

Further, the terms “information” and “data” used in the specification may also be often used to be exchanged with each other.

Suffixes “module” and “unit” for components used in the following description are given or mixed in consideration of easy preparation of the specification only and do not have their own distinguished meanings or roles.

The objects and effects of the present disclosure, and technical constitutions of accomplishing these will become obvious with reference to exemplary embodiments to be described below in detail along with the accompanying drawings. In describing the present disclosure, a detailed description of known function or constitutions will be omitted if it is determined that it unnecessarily makes the gist of the present disclosure unclear. In addition, terms to be described below as terms which are defined in consideration of functions in the present disclosure may vary depending on the intention of a user or an operator or usual practice.

The scope of the claims for the method in the claims of the present disclosure arises from the functions and features described in each step and is not affected by the order in which each step in the claims disclosed if a sequence relationship of the disclosure order in respective steps constituting the method is not specified. For example, in the claims set forth in the method including steps A and B, the scope of rights is not limited to the fact that step A precedes step B, even if step A is described before step B.

However, the present disclosure is not limited to exemplary embodiments disclosed below but may be implemented in various different forms. However, the exemplary embodiments are provided to make the present disclosure be complete and completely announce the scope of the present disclosure to those skilled in the art to which the present disclosure belongs and the present disclosure is just defined by the scope of the claims. Accordingly, the terms need to be defined based on contents throughout this specification.

In the present disclosure, a database server 100 may generate a join tree based on a query including a join operation from a client 200. Here, the join operation may be a task of combining a plurality of values included in a plurality of tables which is present in the database server 100.

Here, the join tree may mean that at least two tables and a join result of at least two tables are structured in a tree form when the join operation of at least two tables is performed. In other words, at least two tables may be disposed on a lower layer of the join tree and the result may be disposed on an upper layer of at least two tables. However, the present disclosure is not limited thereto.

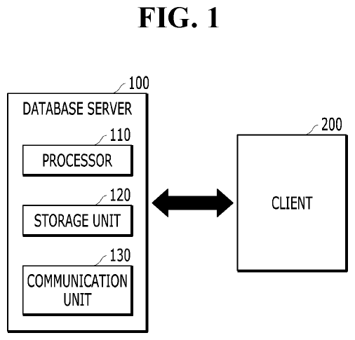

Hereinafter, a join operation algorithm in the present disclosure will be described with reference to FIGS. 1 to 11.

FIG. 1 is a schematic view of an exemplary system including a database server and a client according to some exemplary embodiments of the present disclosure.

Referring to FIG. 1, the system according to some exemplary embodiments of the present disclosure may include a database server 100 and a client 200. However, components described above are not required in implementing the system according to some exemplary embodiments of the present disclosure and the system according to some exemplary embodiments of the present disclosure may thus have components more or less than components listed above.

According to some exemplary embodiments of the present disclosure, the database server 100 and the client 200 may transmit/receive data (signals or queries) for the system according to some exemplary embodiments of the present disclosure through a predetermined network (not illustrated). Here, the network may be configured regardless of communication modes such as wired mode and wireless mode and constituted by various communication networks including a personal area network (PAN), a wide area network (WAN), and the like. Further, the network may be known World Wide Web (WWW) and may adopt a wireless transmission technology used for short-distance communication, such as infrared data association (IrDA) or Bluetooth.

Further, the network may use various wired communication systems such as public switched telephone network (PSTN), x digital subscriber line (xDSL), rate adaptive DSL (RADSL), multi rate DSL (MDSL), very high speed DSL (VDSL), universal asymmetric DSL (UADSL), high bit rate DSL (HDSL), local area network (LAN), Code Division Multi Access (CDMA), Time Division Multi Access (TDMA), Frequency Division Multi Access (FDMA), Orthogonal Frequency Division Multi Access (OFDMA), and Single Carrier-FDMA (SC-FDMA).

Further, the network may include a database link. Accordingly, a plurality of database servers communicates with each other through the database link to bring data from another database server.

The techniques described in the present specification may also be used in other networks in addition to the aforementioned networks.

The client 200 may mean a node(s) in a database system having a mechanism for communication through the network.

For example, the client 200 may mean a predetermined electronic device having network connectivity, such as a cellular phone, a smart phone, a desktop computer, a personal computer, a laptop computer, a digital broadcasting terminal, a digital TV, a digital signage, a personal digital assistants (PDA), a portable multimedia player (PMP), a navigation, a slate PC, a tablet PC, an ultrabook, a wearable device such as a smartwatch, a smart glass, or a head mounted display (HMD), etc. Further, the client 200 may mean a predetermined server implemented by at least one of agent, application programming interface (API), and plug-in. In addition, the client 200 may include an application source and/or a client application. Here, an application source as a source code of a program executed in a client or a database may be created through a programming language including a query by a developer or a user. The application source may be created by the programming language using, for example, PL/SQL (Procedural Language for Structured Query Language), SQLJ, Embedded SQL, and/or client library.

The client 200 may be a predetermined entity which includes a processor and a memory to process and store predetermined data. Further, the client 200 in FIG. 1 may be related with a user which uses the database server 100 or communicates with the database server 100. In such an example, the client 200 may issue the query to the database server 100. Here, the query means a predetermined request or command of requesting processing in a database server and may include, for example, data manipulation language (DML), data definition language (DDL), and/or PL/SQL. Further, the query in the present disclosure may mean a predetermined request issued from a user/developer. In addition, the query may mean a predetermined request input into a user terminal and/or the database server and processed in the user terminal and/or the database server.

According to some exemplary embodiments of the present disclosure, the client 200 may transmit to the database server 100 a query including a join operation prepared by a programming language by a developer, etc. In this case, the database server 100 may generate a join tree in order to generate an optimized plan for performing the join operation included in the query. Here, the join tree may mean information utilized when determining by which method tables are to be joined.

The database server 100 may include a predetermined type of computer system or computer device such as a microprocessor, a mainframe computer, a digital processor, a portable device, and a device controller.

The database server 100 may include a processor 110, a storage unit 120, communication unit 130, and a database management system (DBMS). However, components described above are not required in implementing the database server 100 and the system according to some exemplary embodiments of the present disclosure may thus have components more or less than components listed above.

Although not illustrated in FIG. 1, the database server 100 may include one or more memories including a buffer cache. Accordingly, the database management system may be operated by the processor on the memory.

Here, the memory as a primary storage device directly accessed by the processor, such as a random access memory (RAM) including a dynamic random access memory (DRAM), a static random access memory (SRAM), etc., may mean a volatile storage device in which stored information is momentarily erased when power is turned off, but is not limited thereto. The memory may be operated by control by the processor. The memory may temporarily store a data table including a data value. The data table may include the data value and in the exemplary embodiment of the present disclosure, the data value of the data table may be written in the storage unit 120 from the memory. In an additional aspect, the memory may include the buffer cache and data may be stored in a data block of the buffer cache. The data may be written in the storage unit 120 by a background process.

The storage unit 120 means a non-volatile storage medium which may consistently store predetermined data, such as a magnetic disk, an optical disk, and a magneto-optical storage device and a storage device based on a flash memory and/or a battery-backup memory. The storage unit 120 may communicate with the processor 110 and the memory of the database server 100 through various communication means.

In other some exemplary embodiments, the storage unit 120 is positioned outside the database server 100 to communicate with the database server 100. Further, in FIG. 1, only one storage unit and one DBMS are illustrated, but a type in which a plurality of DBMSs is connected to one storage unit or a type including the plurality of storage units may also be included in the scope of the present disclosure.

The DBMS as a program for permitting the database server 100 to perform operations including retrieval, insertion, modification, and/or deletion of required data may be implemented by the processor 110 in the memory of the database server 100 as described above.

The communication unit 130 may communicate with the client 200 or another database server by using the aforementioned predetermined network and/or database link. In some exemplary embodiments of the present disclosure, the communication unit 130 may receive the query including the join operation from the user terminal. In addition, the communication unit 130 transfers to the client 200 a processing result of the query performed with respect to an optimized physical plan complied and generated by the processor 110.

The processor 110 controls all operations of the database server 100. The processor 110 processes a signal, data, information, and the like input or output through the components or drives the application program stored in the memory to provide or process appropriate information or function.

The processor 110 may drive an operating system (OS), an application, and a database manager for driving the database server 100.

The processor 110 may be a central processing unit (CPU), a co-processor, an arithmetic processing unit (APU), a graphic processing unit (GPU), a digital signal processor (DSP), an application processor (AP), and a communication processor (CP).

When the processor 110 receives the query including the join operation from the client 200, a join order of tables may be determined for optimization of the join operation. A throughput of the processor 110 may be significantly changed according to the join order, and as a result, the throughput may be very important in determining the join order.

Meanwhile, the processor 110 may recognize whether there is at least one join predicate is present in the query received from the client 200 through the communication unit 130. Here, the join predicate may mean that at least one same column is included in at least two tables.

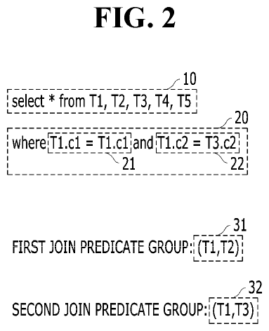

For example, the query which the processor 110 receives from the client 200 through the communication unit 130 may include a statement that a first column c1 of a first table T1 and the first column c1 included in a second table T2 are the same as each other. In this case, the processor 110 may recognize that the first table T1 and the second table T2 are the join predicate. However, the present disclosure is not limited thereto. Hereinafter, contents related to the join predicate will be described below through FIGS. 2 to 11.

Meanwhile, although not illustrated in FIG. 1, the processor 110 may include a parser, a transformer, an optimizer, and an executor. However, components described above are not required in implementing the processor 110 and the processor 110 may thus have components more or less than components listed above. Meanwhile, the components included in the processor 110 may be implemented as hardware or software.

The parser may check Syntax and Semantic information for the query received through the communication unit 130. For example, in relation with verification of Syntax, Inline view, Subquery, Outer Join, Connect By, Updatable Join View, Partitioned Table, Cube/Rollup, Analytic Functions, Merge Into, Hint, Materialized View, and the like may be checked.

In relation with verification of the Semantic information, the parser may identify database objects and check a privilege. Further, the parser may generate a logical execution plan for the received query. The logical execution plan may be generated in a tree structure. Further, the parser may check identifiers for the database objects and perform the View inline operations, and the like.

The transformer may convert the logical execution plan generated by the parser into a better or another logical plan. The processing result for the converted logical plan is the same as the processing result depending on the logical plan generated by the parser. That is, the transformer may generate a logical plan of a type in which an execution time may become short or generate a plan in which the optimizer may consider more physical execution plans.

For example, features which may be processed by the transformer may include Join Elimination, Hash Join, Nested-loop Join, Sort Merge Join, Remote Join, Inner Join, Aggregation Join, Equi Join, Maxlrow Join, Index Join, Outer-Join, Simplification, View Merging, Subquery Unnesting, Subquery Elimination, Aggregation Subquery Elimination, Orderby Elimination, and/or Subquery Coalescing.

The optimizer may create a physical execution plan of which the execution time is anticipated to be shortest from the logical execution plan generated by the transformer. For example, the optimizer may determine operations which need to be actually executed by the executor with respect to nodes of respective logical execution plans and determine an execution order of the operations. The optimizer may perform cost-based optimization and herein, the cost may include processing cost of I/O and a CPU (alternatively, GPU). Here, the cost is a concept widely used in a database management system field and a detailed description thereof is omitted.

In FIG. 1, one database server and one user terminal are exemplarily illustrated, but it will be apparent to those skilled in the art that more database servers (management apparatuses) and user terminals there than may also be included in the scope of the present disclosure.

FIG. 2 is a diagram for describing an example of a join predicate according to some exemplary embodiments of the present disclosure.

Referring to FIG. 2, the query which the communication unit 130 of the database server 100 receives from the client 200 may include a first statement 10. Here, the first statement 10 may mean selecting a first table T1 to a fifth table T5.

That is, when the first statement 10 is received, the processor 110 may perform the join operation in the first table T1 to the fifth table T5.

Meanwhile, the query which the communication unit 130 of the database server 100 receives from the client 200 may include a second statement 20. Here, the second statement 20 may include contents that the first column c1 of the first table T1 and the first column c1 of the second table T2 are the same as each other. Further, the second statement 20 may include contents that the second column c2 of the first table T1 and a second column c1 of the third table T3 are the same as each other. In this case, the processor 110 may recognize the first column c1 of the first table T1 and the first column c1 of the second table T2 as a first join predicate 21. Further, the processor 110 may recognize the second column c2 of the first table T1 and the second column c2 of the third table T3 as a second join predicate 22.

Meanwhile, when the first join predicate 21 is recognized, the processor 110 of the database server 100 may generate a first join predicate group 31 based on the tables included in the first join predicate 21. Here, the join predicate group may mean grouping at least one join predicate. For example, the first join predicate group 31 may include the first table T1 and the second table T2. Further, the processor 110 may generate a second join predicate group 32 based on the second join predicate 22. In this case, the second join predicate group 32 may include the first table T1 and the third table T3. However, the present disclosure is not limited thereto.

As described above, when the processor 110 of the database server 100 receives the query including the join operation from the client 200 through the communication unit 130, the processor 110 may generate at least one join predicate group through a plurality of tables.

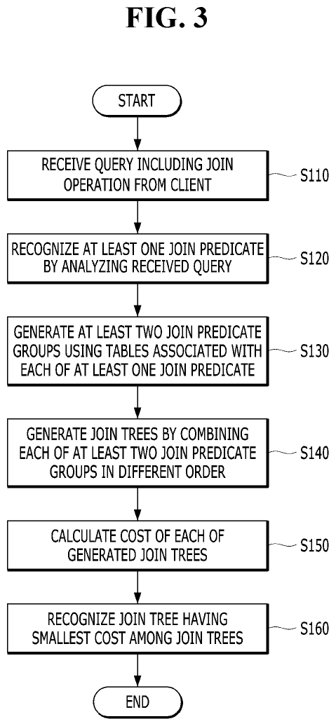

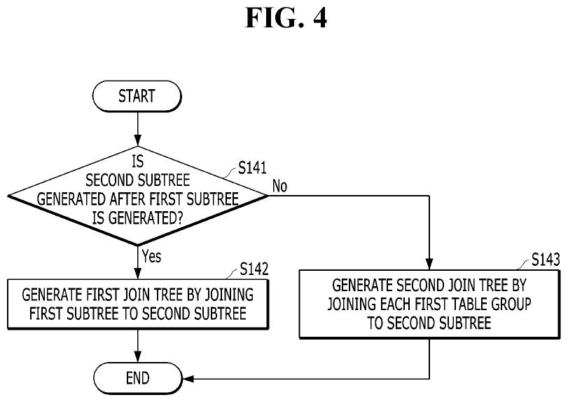

Meanwhile, when the processor 110 generates at least one join predicate group, the processor 110 may first perform the join operation for the generated join predicate group. In this case, since the join operation is performed by methods described later in FIGS. 3 and 4, the processor 110 may reduce cost which is caused in performing the join operation. Here, the cost may be a resource amount of the memory (RAM) used in performing a series of operations by the processor 110. Hereinafter, an operation in which the processor 110 recognizes a join tree having smallest cost in performing the join operation of the plurality of tables will be described below through FIG. 3.

FIG. 3 is a flowchart for describing an example of a method for selecting an optimal join tree by a processor according to some exemplary embodiments of the present disclosure.

Referring to FIG. 3, the communication unit 130 of the database server 100 may receive the query including the join operation from the client 200 (S110).

Specifically, the communication unit 130 may receive from the client 200 a query including an instruction of performing the join operation for at least two tables stored in the storage unit 120 and at least one join predicate.

For example, the query which the communication unit 130 receives from the client 220 may include the first statement 10 and the second statement 20. However, the present disclosure is not limited thereto.

The processor 110 of the database server 100 analyzes the query received through the communication unit 130 to recognize at least one join predicate (S120).

Specifically, the processor 110 may recognize whether the second statement 20 is included in the query. In addition, the processor 110 may recognize at least one join predicate based on the second statement 20. Here, the second statement 20 may be a where clause meaning a condition equation in the query. However, the present disclosure is not limited thereto.

For example, as described with reference to FIG. 2, when the processor 110 interprets the second statement 20 to recognize that the first column c1 of the first table T1 and the first column c1 of the second table T2 are the same as each other, the processor 110 may recognize the first join predicate 21 that the first column c1 of the first table T1 and the first column c1 of the second table T2 are the same as each other. Further, when the processor 110 interprets the second statement 20 to recognize that the second column c2 of the first table T1 and the second column c2 of the third table T3 are the same as each other, the processor 110 may recognize the second join predicate 22 that the second column c2 of the first table T1 and the second column c2 of the third table T3 are the same as each other. However, the present disclosure is not limited thereto.

Meanwhile, the processor 110 of the database server 100 may generate at least two join predicate groups by using tables related to each of at least one join predicate (S130).

Specifically, when at least one join predicate includes the first join predicate 21 and the second join predicate 22, the processor 110 may generate the first join predicate group 31 by using a first table group related to the first join predicate 21 and generate the second join predicate group 32 by using a second table group related to the second join predicate.

For example, the processor 110 may generate the first join predicate group 31 by using the first table T1 and the second table T2 included in the first join predicate 21. Further, the processor 110 may generate the second join predicate group 32 by using the first table T1 and the third table T3 included in the second join predicate 22. However, the present disclosure is not limited thereto.

Meanwhile, the processor 110 of the database server 100 may generate the join trees by combining each of at least two join predicate groups in a different order (S140).

Here, the join tree may mean that when the join operation of each of at least two join predicate groups is performed, at least two join predicate groups and a join result of at least two join predicate groups are structured in a tree form. Here, the result may mean that a join result of two join predicate groups is generated. However, the present disclosure is not limited thereto.

For example, when the processor 110 performs the join operation in the first join predicate group 31 and the second join predicate group 32, the result may be generated. In this case, the processor 110 may recognize as the join tree a structure of the tree structure including the generated result, the first join predicate group 31, and the second join predicate group 32. Here, the result may be disposed on an upper layer of the join tree and the first join predicate group 31 and the second join predicate group 32 may be disposed on the lower layer of the result. However, the present disclosure is not limited thereto.

Meanwhile, according to some exemplary embodiments of the present disclosure, the processor 110 of the database server 100 may generate a first subtree by joining the first table T1 and the second table T2 included in the first join predicate group 31. Here, the subtree may mean that at least two tables and the result are structured in the tree form when the join operation of at least two tables included in at least two join predicate groups is performed. For example, when the join operation of the first table T1 and the second table T2 is performed, the join result of the first table T1 and the second table T2 may be disposed on the upper layer of the subtree and the first table T1 and the second table T2 may be disposed on the lower layer of the result. However, the present disclosure is not limited thereto.

Meanwhile, the processor 110 may generate at least one join tree by joining at least one table included in the second join predicate group 32 in the first subtree. Hereinafter, a method in which the processor 110 generates at least one subtree will be described below with reference to FIG. 4.

Meanwhile, the processor 110 of the database server 100 may calculate the cost of each of the join trees generated in step S140 (S150).

Here, the cost may be a resource amount of the memory (RAM) used in performing a series of operations by the processor 110. The resource amount of the memory provided in the database server 100 may be finite. In this case, when the resource amount generated as the processor 110 performs the join operation is more than the resource amount of the memory, an error may occur in the memory or the processor 110. Further, the cost generated when the processor 110 performs the join operation may be related to a speed of the operation. Accordingly, the processor 110 needs to consider the cost generated in performing the join operation.

Specifically, the cost when the processor 110 performs the join operation for each table written to the storage unit 120 may be written to the storage unit 120. In this case, the processor 110 may recognize the cost generated when performing the join operation in at least two tables by scanning the storage unit 120. Accordingly, the processor 110 may calculate each cost generated at the time of generating the join trees. However, the present disclosure is not limited thereto.

Meanwhile, the processor 110 of the database server 100 may recognize a join tree having smallest cost among join trees (S160).

Specifically, the processor 110 may calculate the cost generated at the time of generating at least one join tree. In addition, the processor 110 may recognize the join tree having the smallest cost by comparing the costs generated at the time of generating at least two join trees.

For example, the processor 110 may recognize that cost generated when the join operation of the first join predicate group 31 and the second join predicate group 32 in a first order is performed is “101”. In addition, the processor 110 may recognize that cost generated when the join operation of the first join predicate group 31 and the second join predicate group in a second order is performed is “102”. In this case, the processor 110 may recognize that the cost of the join tree generated in the first order is the smallest. However, the present disclosure is not limited thereto.

That is, the processor 110 may recognize as an optimal join tree the join tree having the smallest cost among the join trees generated in step S140.

Meanwhile, in the present disclosure, when the join tree having the smallest cost is recognized among the join trees, the processor 110 of the database server 100 may store the join tree in the storage unit 120 or perform the join operation in an order of the generated join tree. However, the present disclosure is not limited thereto.

As described above, the processor 110 of the database server 100 may perform the join operation by analyzing the query received from the client 200 through the communication unit 130. In addition, the processor 110 may recognize the join tree which may be generated with smallest cost in performing the join operation for the plurality of tables.

Meanwhile, the processor 110 of the database server 100 may generate the subtree by first performing the join operation of at least two tables included in at least one join predicate group when combining each of at least two join predicate groups. Hereinafter, a method in which the processor 110 generates at least one subtree will be described below with reference to FIG. 4.

FIG. 4 is a flowchart for describing an example of a method for generating at least one join tree by using a subtree by a processor according to some exemplary embodiments of the present disclosure.

First, in step S130 of FIG. 3, the processor 110 may generate at least two join predicate groups by using tables related to each of at least one join predicate.

Specifically, when at least one join predicate includes the first join predicate 21 and the second join predicate 22, the processor 110 may generate the first join predicate group 31 by using a first table group related to the first join predicate 21 and generate the second join predicate group 32 by using a second table group related to the second join predicate.

For example, the processor 110 may generate the first join predicate group 31 by using the first table T1 and the second table T2 included in the first join predicate 21. Further, the processor 110 may generate the second join predicate group 32 by using the first table T1 and the third table T3 included in the second join predicate 22.

In addition, in step S140 of FIG. 3, the processor 110 may generate the join trees by combining each of at least two join predicate groups in a different order.

Meanwhile, each of at least two join predicate groups may be combined in a different order according to an order in which the processor 110 generates the subtree for at least one join predicate group in step S140.

Specifically, referring to FIG. 4, when the processor 110 of the database server 100 generates a first subtree and then generates a second subtree (Yes in S141), the processor 110 joins the first subtree to the second subtree to generate the first join tree (S142).

More specifically, the processor 110 may generate the first subtree by performing the join operation for the first table T1 and the second table T2 of the first join predicate group 31 before performing the join operation for the table group included in the second join predicate group 32. In addition, the processor 110 may generate the second subtree by performing the join operation for the first table T1 and the third table T3 of the second join predicate group 32. In this case, the processor 110 may recognize that the first subtree is generated and then the second subtree is generated.

Meanwhile, when the first subtree and the second subtree are generated, the processor 110 may generate the first join tree by joining the first subtree to the second subtree. However, the present disclosure is not limited thereto.

Meanwhile, when the processor 110 of the database server 100 generates the second subtree before generating the first subtree (No in S141), the processor 110 may generate the second join tree by joining each first table group to the second subtree (S143).

Specifically, the processor 110 may generate the second subtree by performing the join operation for the first table T1 and the third table T3 of the second join predicate group 32 before performing the join operation of the first join predicate group 31. In this case, the processor 110 may generate the second join tree by joining each first table group to the second subtree.

For example, the processor 110 may generate the second join tree by joining each of the first table T1 and the second table T2 to the second subtree. However, the present disclosure is not limited thereto.

Meanwhile, according to some exemplary embodiments of the present disclosure, when the processor 110 of the database server 100 joins each first table group to the second subtree, at least one table may be joined to the second subtree.

For example, the processor 110 may generate the second subtree by performing the join operation for the first table T1 and the third table T3 included in the second join predicate group 32. In this case, the first table group may include the first table T1 and the second table T2. In this case, the processor 110 may recognize that the first table T1 is already included in the second subtree. Accordingly, when the processor 110 joins each first table group to the second subtree, the processor 110 may perform only the join operation of the second subtree and the second table T2. However, the present disclosure is not limited thereto.

Meanwhile, according to some exemplary embodiments of the present disclosure, the cost generated when generating the first join tree and the cost generated when generating the second join tree may be different from each other.

Specifically, when the processor 110 of the database server 100 generates the first join tree, the first subtree and the second subtree should be able to be first generated. On the contrary, the processor 110 may generate the second join tree by performing the join operation only for the second table T2 after generating the second subtree. Accordingly, the cost generated when generating the first join tree and the cost generated when generating the second join tree may be different from each other.

In this case, the processor 110 may calculate each of the cost generated when generating the first join tree and the cost generated when generating the second join tree. In addition, the processor 110 may recognize a join tree having smaller cost among costs generated while generating the first join tree and the second join tree. However, the present disclosure is not limited thereto.

Through the above description, the processor 110 of the database server 100 may perform the join operation for each of at least two join predicate groups in a different order.

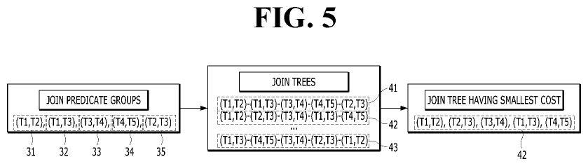

Meanwhile, in FIGS. 3 and 4, the method of performing the join operation of the first join predicate group 31 and the second join predicate group 32 is described for convenience of description, but the query which the communication unit 130 receives from the client 200 may include a join operation request for more quantities of tables. Hereinafter, a method in which the processor 110 recognizes a join tree having the smallest cost among the join trees will be described with reference to FIG. 5.

FIG. 5 is a diagram for describing an example of a method for recognizing a join tree having the smallest cost among join trees by a processor according to some exemplary embodiments of the present disclosure.

Referring to FIG. 5, the join predicate groups generated by the processor 110 of the database server 100 may include a first join predicate group 31, a second join predicate group 32, a third join predicate group 33, a fourth join predicate group 34, and a fifth join predicate group 35. However, the present disclosure is not limited thereto.

The tables included in each join predicate group may be tables which the processor 110 groups by recognizing the join predicate. In other words, the tables included in at least one join predicate group may be tables in which at least one column is the same. However, at least one table may not be related to at least one rest table. In this case, at least one table may be bound with at least one table even though there is no join predicate.

For example, the second table T2 and the fifth table T5 may have no join predicate. However, when all other tables are bound, the second table T2 and the fifth table T5 may be bound as the join predicate. However, the present disclosure is not limited thereto.

Meanwhile, the processor 110 may generate the join trees by combining each of at least two join predicate groups in a different order.

For example, the processor 110 may generate the join trees when receiving the query including the first to fifth join predicate groups 31 to 35 based on the methods described in FIGS. 3 and 4.

The join trees may include a third join tree 41, a fourth join tree 42, and a fifth join tree 43.

For example, the third join tree 41 may be a join tree including information that the join operation is performed in the order of the first join predicate group 31, the second join predicate group 32, the third join predicate group 33, the fourth join predicate group 34, and the fifth join predicate group 35.

Meanwhile, the processor 110 of the database server 100 may calculate the cost of each of the generated join trees. For example, the processor 110 may calculate the cost generated when generating at least join tree by scanning the cost generated when generating at least one join tree stored in the storage unit 120. In addition, the processor 110 may recognize the join tree having the smallest cost based on a calculated result. In this case, the processor 110 of the database server 100 may store the join tree having the smallest cost in the storage unit 120.

For example, when the processor 110 recognizes that the fourth join tree 42 has the smallest cost among the join trees, the processor 110 may recognize the fourth join tree 42 as the join tree having the smallest cost. In this case, the processor 110 may perform the join operation by using the fourth join tree 42.

Meanwhile, according to some exemplary embodiments of the present disclosure, an operation of the processor 110 of the database server 100 recognizing the join tree having the smallest cost may require a lot of time. However, a time which a user or the client 200 has may be limited. In this case, the processor 110 may recognize the join tree having the smallest cost for a predetermined time. Here, the predetermined time may be stored in the storage unit 120 in advance or included in the query which the communication unit 130 receives from the client 200. However, the present disclosure is not limited thereto.

Specifically, upon receiving the query including the join operation from the client 200 through the communication unit 130, the processor 110 may recognize whether there is a time attack in the received query. In addition, when the time attack is present in the received query, the processor 110 may recognize the predetermined time stored in the storage unit 120 or recognize the predetermined time included in the query.

Meanwhile, when the predetermined time is recognized, the processor 110 may generate the join trees by combining each of at least two join predicate groups in a different order for the predetermined time. In addition, the processor 110 may recognize the join tree having the smallest cost among the join trees combined for the predetermined time. However, the present disclosure is not limited thereto.

Through the above description, the processor 110 of the database server 100 may recognize the join tree having the smallest cost in performing the join operation of the join predicate groups.

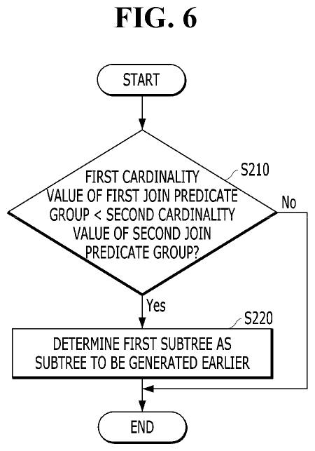

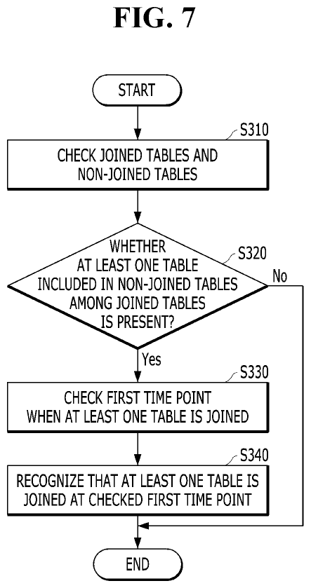

Meanwhile, when the processor 110 of the database server 100 performs the join operation for the join predicate groups, the processor 110 may use join selectivity in order to determine the priority. Hereinafter, a method for determining the priority of the join predicate groups of which join operation is to be performed by using the join selectivity will be described with reference to FIGS. 6 and 7.

FIG. 6 is a flowchart for describing an example of a method for determining a priority of a join tree to be generated at the time of generating the join tree by a processor according to some exemplary embodiments of the present disclosure.

First, when the processor 110 of the database server 100 generates the first subtree and the second subtree in step S142 of FIG. 4, the processor 110 joins the first subtree to the second subtree to generate the first join tree.

Specifically, when the processor 110 intends to first generate the first subtree, the processor 110 may perform the join operation of the first table T1 and the second table T2 included in the first join predicate group 31. In this case, the first subtree may be generated in which the first table T1 and the second table T2 are included in the lower layer and the join result of the first table T1 and the second table T2 is included in the upper layer. Further, after the first subtree is generated, the processor 110 may perform the join operation of the first table T1 and the third table T3 included in the second join predicate group 32. In this case, the second subtree may be generated in which the first table T1 and the third table T3 are included in the lower layer and the join result of the first table T1 and the third table T3 is included in the upper layer. In addition, the processor 10 may generate the second join tree by joining the first subtree to the second subtree.

Meanwhile, according to some exemplary embodiments of the present disclosure, the processor 110 of the database server 100 may recognize whether to first generate the first subtree or the second subtree before generating the first subtree and the second subtree. In addition, the processor 110 may determine at least one subtree to be first generated between the first subtree and the second subtree. The reason is that the cost generated when the processor 110 performs the join operation may vary depending on a generating order of at least one join tree.

Specifically, the processor 110 may recognize a cardinality value of each of the first join predicate group 31 and the second join predicate group 32 by using a first value acquired by multiplying the numbers of rows of respective first table groups, a second value acquired by multiplying the numbers of rows of respective second table groups, first join selectivity related to the first table group, and second join selectivity related to the second table group.

Here, the join selectivity may be a ratio of performing the join operation for at least two tables when performing the join operation of all tables.

Specifically, when the processor 110 of the database server 100 generates the join trees by combining the first join predicate group 31 to the fifth join predicate group 35 in a different order, the processor 110 may recognize a ratio of the tables included in the first table group, of which join operation is performed.

For example, the number of times when the processor 110 should join at least two tables in order to generate the join trees by combining the first join predicate group 31 to the fifth join predicate group 35 in a different order may be 1000. In this case, the number of times when the first table T1 and the second table T2 of the first table group should be joined may be 1. In this case, the first join selectivity related to the first table group may be 0.001. However, the present disclosure is not limited thereto.

Meanwhile, the cardinality value may be a value output by multiplying the first join selectivity by the first value.

For example, the processor 110 of the database server 100 may calculate a first cardinality value as “10” by multiplying “0.001” which is the first join selectivity and “10000” which is the first value acquired by multiplying the numbers of rows of the respective first table groups. However, the present disclosure is not limited thereto.

Meanwhile, the processor 110 of the database server 100 may determine an order to perform the join operation by using the first join cardinality value of the first join predicate group 31 and the second join cardinality value of the second join predicate group 32.

Specifically, referring to FIG. 6, when the processor 110 recognizes that the first cardinality value is smaller than the second cardinality value (Yes in S210), the processor 110 may determine the first subtree as the subtree to be first generated (S220).

For example, the processor 110 may calculate the first cardinality value as “10” by multiplying “0.001” which is the first join selectivity and “10000” which is the first value acquired by multiplying the numbers of rows of the respective first table groups. Further, the processor 110 may calculate the second cardinality value as “100” by multiplying “0.01” which is the second join selectivity and “10000” which is the first value acquired by multiplying the numbers of rows of the respective second table groups. In this case, the processor 110 may recognize that the first cardinality value is smaller by comparing the first cardinality value and the second cardinality value. Accordingly, the processor 110 may determine the first subtree as the subtree to be generated earlier than the second subtree. However, the present disclosure is not limited thereto.

Meanwhile, when the processor 110 of the database server 100 recognizes that the first cardinality value is larger than the second cardinality value (No in S210), the processor 110 may determine the second subtree as the subtree to be generated earlier.

Meanwhile, according to some exemplary embodiments of the present disclosure, an operation of the processor 110 of the database server 100 generating the join trees by combining each of at least two join predicate groups in a different order may be performed in parallel.

For example, when a statement related to a parallel join operation is included in the query received from the client 200 through the communication unit 130, the processor 110 may generate the first subtree and the second subtree in parallel. In addition, the processor 10 may perform the join operation for the generated first subtree and second subtree. However, the present disclosure is not limited thereto.

Meanwhile, according to some exemplary embodiments of the present disclosure, the query including the join operation, which the communication unit 130 of the database server 100 receives from the client 200 may include the order for the join operation. In this case, the processor 110 may recognize the order of generating the join trees. In addition, the processor 110 may generate the join trees based on the recognized order. However, the present disclosure is not limited thereto.

When the processor 110 of the database server 100 considers the cardinality value at the time of generating the plurality of join trees, the cost which may be generated when the plurality of join trees is generated may be reduced.

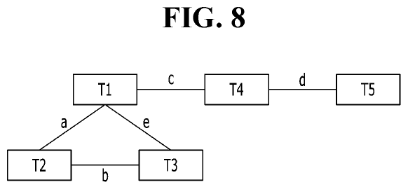

Meanwhile, when the processor 110 of the database server 100 generates the join trees by combining each of at least two join predicate groups in a different order, at least one table may be included in at least one join tree of which join operation is already performed. Hereinafter, a method for checking joined tables and non-joined tables by the processor 110 will be described with reference to FIGS. 7 and 8.

FIG. 7 is a flowchart for describing an example of a method for checking a joined table group and a non-joined table group by a processor according to some exemplary embodiments of the present disclosure. FIG. 8 is a flowchart for describing an example of a method for checking a joined table group and a non-joined table group by a processor according to some exemplary embodiments of the present disclosure.

First, referring to FIG. 8, the query including the join operation, which the communication unit 130 of the database server 100 receives from the client 200 may include an instruction of performing the join operation of the first table T1, the second table T2, the third table T3, the fourth table T4, and the fifth table T5.

Further, the processor 110 may recognize at least one join predicate included in the received query. In addition, the processor 110 may generate the join predicate groups and combine the respective join predicate groups in a different order. In this case, at least one table may be joined to at least one join tree before the join operation is performed.

For example, the processor 110 may perform the join operation for at least one table in a third order which is an order such as “a-b-c-d-e”.

More specifically, for example, the processor 110 may first perform a first join operation a of the first table T1 and the second table T2. In addition, the processor 110 may perform a second join operation b of a third result which is the result of the first join operation a and the third table T3. Further, the processor 110 may perform a third join operation c of a fourth result which is the result of the second join operation b of the third result and the third table T3 and the fourth table T4. Similarly, the processor 110 may perform a fourth join operation d of a fifth result which is the result of the third join operation c of the fourth result and the fourth table T4 and the fifth table T5.

In this case, the processor 110 should perform a fifth join operation e of the first table T1 and the third table T3, but the third table T3 may be already joined.

Specifically, referring to FIG. 7, the processor 110 of the database server 100 may check joined tables and non-joined tables (S310).

For example, when the processor 110 performs the first join operation a, the second join operation b, and the third join operation c, the processor 110 may recognize that the first table T1, the second table T2, the third table T3, and the fourth table T4 are joined. In addition, the processor 110 may recognize that the fifth table T5 is not yet joined. In this case, the processor 110 may perform the fourth join operation d for the fifth result of the third join operation c and the fifth table T5. However, the present disclosure is not limited thereto.

When the processor 110 of the database server 100 recognizes that at least one table included in the non-joined tables among the joined tables is not present (No in S320), the processor 110 may not check a first time point which is a time when at least one table is joined.

For example, the third table T3 may not have at least one join predicate with the first table T1 and the second table T2. In this case, only when the processor 110 performs all of the first join operation a, the second join operation b, the third join operation c, the fourth join operation d, and the fifth join operation e, all join operations for the first table T1 to the fifth table T5 may be completed. Accordingly, in this case, the processor 110 may not check the first time point. However, the present disclosure is not limited thereto.

Meanwhile, when the processor 110 of the database server 100 recognizes that at least one table included in the non-joined tables among the joined tables is present (Yes in S320), the processor 110 may check the first time point when at least one table is joined.

For example, when the processor 110 intends to perform the fifth join operation e for the third table T3 after performing the fourth join operation d, the processor 110 may recognize that the join operation is already performed for the third table T3. In this case, the processor 110 may check the first time point when the second join operation b is performed. However, the present disclosure is not limited thereto.

In addition, the processor 110 of the database server 100 may recognize that at least one table is joined at the first time point (S340).

For example, the processor 110 may recognize as the first time point a time point of performing the second join operation b of the third result which is the result of the first join operation a and the third table T3.

Meanwhile, when the first time point is recognized, the processor 110 may recognize at least two tables related to the first time point. In addition, the processor 110 may recognize at least one join predicate for at least two tables. However, the present disclosure is not limited thereto.

Meanwhile, when at least one join predicate related to the first time point is recognized, the processor 110 may recognize that at least one join predicate should be joined at the first time point. In this case, the processor 110 may join at least one recognized join predicate at the first time point when generating at least one join tree. However, the present disclosure is not limited thereto.

For example, the processor 110 may recognize that the third table T3 should be joined at the first time point. In this case, the processor 110 may perform the fifth join operation e related to the third table T3 at the first time point after performing the second join operation b. However, the present disclosure is not limited thereto.

Meanwhile, according to some exemplary embodiments of the present disclosure, when the processor 110 of the database server 100 generates the join trees by combining each of at least two join predicate groups in a different order, a common part may be recycled.

For example, the processor 110 may generate at least two join trees of which join operation is performed in a first order (a-b-c-d-e) and a second order (a-b-d-c-e). In this case, the orders in which the first join operation a and the second join operation b are performed may be the same as each other in the first order and the second order.

In this case, when the processor 110 generates the join tree in at least one order of the first order (a-b-c-d-e) and the second order (a-b-d-c-e), the processor 110 may store in the storage unit 120 sub join trees for which the first join operation a and the second join operation b are performed. In addition, when the processor 110 generates the join tree in at least one order of the first order (a-b-c-d-e) and the second order (a-b-d-c-e), the processor 110 may utilize the sub join tree. In this case, the operation of the processor 110 generating the join trees by combining each of at least two join predicate groups in a different order may be faster.

Meanwhile, according to some exemplary embodiments of the present disclosure, when the processor 110 of the database server 100 generates at least one join tree, the processor 110 may use a Cartesian join.

Specifically, the processor 110 may recognize a third value acquired by multiplying the numbers of rows of at least two respective tables without the join predicate. In addition, the processor 110 may first perform the join operation for at least two tables without the join predicate when the third value belongs to a predetermined range.

Here, the predetermined range may be included in the query which the storage unit 120 or the communication unit 130 receives from the client 200. Meanwhile, the predetermined range may be 0.1% to 10% of the number of rows included in at least one table.

Specifically, the processor 110 may recognize the numbers of rows of the tables included in the join predicate groups. In addition, the processor 110 may recognize at least one table having rows which are 0.1% to 10% of a table having most rows. In this case, the processor 110 may first perform the join operation for tables having rows within a predetermined range.

For example, referring back to FIG. 8, the second table T2 and the fourth table T4 may have no join predicate. Accordingly, join operation priorities for the second table T2 and the fourth table T4 may be low.

On the contrary, the third value acquired by multiplying the numbers of rows of the second table T2 and the fourth table T4, respectively may belong to a predetermined range. In this case, the processor 110 may first perform the join operation of the second table T2 and the fourth table T4. However, the present disclosure is not limited thereto.

When the processor 110 performs the join operation by using the Cartesian join as described above, at least one join tree in which small cost is generated may be first generated. Accordingly, the operation of the join operation performed by the processor 110 may be faster.

Meanwhile, according to some exemplary embodiments of the present disclosure, the processor 110 of the database server 100 may perform the join operation for a sixth table without the join predicate based on selectivity.

Specifically, the processor 110 may recognize the sixth table without the join predicate. That is, the processor 110 may recognize the sixth table as the table without the join predicate even with any one table of the plurality of tables. In addition, the processor 110 may recognize a seventh table which is a table having highest selectivity among the tables which belong to the join predicate groups. When the processor 110 recognizes the sixth table and the seventh table, the processor 110 may perform the join operation for the sixth table and the seventh table. The reason is that at least one table in which cost is generated small at the time of generating the join tree among at least one table without the join predicate may be present.

Accordingly, when the processor 110 performs the join operation for the sixth table and the seventh table, the processor 110 may recognize cost generated while performing the join operation for the sixth table and the seventh table. However, the present disclosure is not limited thereto.

As described above, when the processor 110 of the database server 100 generates the join trees by combining each of at least two join predicate groups in a different order, the processor 110 may recognize a time point when at least one table included the non-joined tables is joined. In addition, when the processor 110 generates new join trees by checking at least one table, the processor 110 may perform the join operation faster by utilizing the time point when the at least one table is joined.

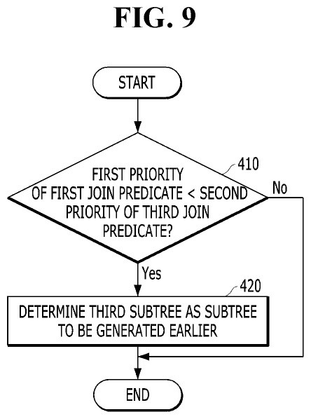

Meanwhile, the orders in which the processor 110 of the database server 100 combines each of at least two join predicate groups may be included in the query received from the client 200 through the communication unit 130. Hereinafter, a method for determining the join tree to be first generated will be described with reference to FIG. 9.

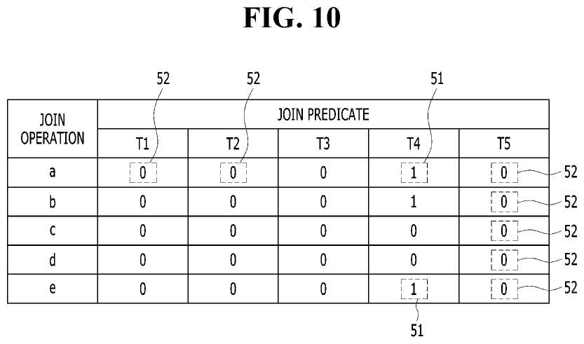

FIG. 9 is a flowchart for describing an example of a method for determining a join tree to be first generated by a processor according to some exemplary embodiments of the present disclosure. FIG. 10 is a diagram for describing an example of a method for determining a join tree to be first generated by a processor according to some exemplary embodiments of the present disclosure.

The query which the communication unit 130 of the database server 100 receives from the client 200 may include a marking that at least one join operation related to at least one table should be first performed. Here, the marking may mean that the client 200 or the user makes a mark in at least one table in which the join operation is to be first performed.

In this case, the processor 110 may recognize that the marking is included in at least one table. In addition, the processor 110 may generate a driver bitmap based on the marking related to at least one table. Herein, the driver bitmap may be a table type map created for to the processor 110 to recognize the join operation to be first performed based on at least one marking. However, the present disclosure is not limited thereto.

Specifically, referring to FIG. 10, the query which the communication unit 130 of the database server 100 receives from the client 200 may include a marking that at least one join operation related to the fourth table T4 should be first performed. In this case, the processor 110 may generate the driver bitmap illustrated in FIG. 10.

Meanwhile, when the processor 110 of the database server 100 generates the driver bitmap, the processor 110 may display a third value 51 and a fourth value 52 in the driver bitmap based on at least one marking received from the client 200 through the communication unit 130. In addition, the processor 110 may recognize the third value 51 and the fourth value 52 at the time of generating at least one join tree.

For example, the processor 110 recognizes the driver bitmap to recognize that the third value 51 is included in the fourth table T4 before performing the first join operation a. In this case, the first join operation a may be a join operation for the first table T1 and the second table T2. Accordingly, the fourth table T4 may not be related to the first join operation a. Therefore, the processor 110 may not generate the join trees in which the first join operation a is first performed. However, the present disclosure is not limited thereto.

Meanwhile, the processor 110 recognizes the driver bitmap to recognize that the third value 51 is included in the fourth table T4 before performing the third join operation c. In this case, the third join operation c may be a join operation for the first table T1 and the fourth table T4. In other words, the fourth table T4 may be included in the third join operation c. In this case, the processor 110 may generate the join trees in which the third join operation c is first performed. However, the present disclosure is not limited thereto.

Meanwhile, the processor 110 may determine the subtree to be generated earlier between the first subtree and the third subtree according to a first priority of the first join predicate and a second priority of the third join predicate.

Specifically, referring to FIG. 9, when the processor 110 of the database server 100 recognizes that the first priority is lower than the second priority (Yes in S410), the processor 110 may determine the third subtree as the join tree to be first generated (S420).

More specifically, the processor 110 may recognize that the third value 51 is not included in at least one of the first table T1 and the second table T2 before performing the first join operation a for the first table T1 and the second table T2 included in the first join predicate. In addition, the processor 110 may recognize that the third value 51 is included in at least one of the first table T1 and the fourth table T4 before performing the third join operation c for the first table T1 and the fourth table T4 included in the third join predicate. In this case, the processor 110 may recognize that the second priority of the third join predicate is higher than the first priority of the first join predicate. In addition, the processor 110 may determine the third subtree as the subtree to be generated earlier based on the second priority. However, the present disclosure is not limited thereto.

Meanwhile, when the processor 110 of the database server 100 recognizes that the first priority is higher than the second priority (No in S410), the processor 110 may determine the first subtree as the subtree to be generated earlier. However, the present disclosure is not limited thereto.

Meanwhile, according to some exemplary embodiments of the present disclosure, the processor 110 of the database server 100 may use a heuristic join. Specifically, referring back to FIG. 8, the priority of the fourth join operation d for the first table T1 and the fourth table T4 may be low. The reason is that the join predicate may not be present between the first table T1 and the fourth table T4.

Meanwhile, when the processor 110 combines the join predicate groups in all orders, at least one join tree in which the fourth join operation d is first performed may be generated. However, the time attack may be present in the query which the processor 110 receives from the client 200 through the communication unit 130. In this case, at least one join tree which the processor 110 generates within a limited time may not include at least one join tree in which the fourth join operation d is first performed.

Accordingly, when the processor 110 generates the join trees, the processor may first perform the join operation for at least two tables without the join predicate.

For example, the processor 110 may generate at least one join tree in which the fourth join operation d is first performed. In addition, the processor 110 may calculate the cost of at least one join tree in which the fourth join operation d is first performed. However, the present disclosure is not limited thereto.

Through the above description, when the processor 110 receives a query including a request for first performing the join operation of at least one table from the client 200 through the communication unit 130, the processor 110 may first perform the join operation for at least one table.

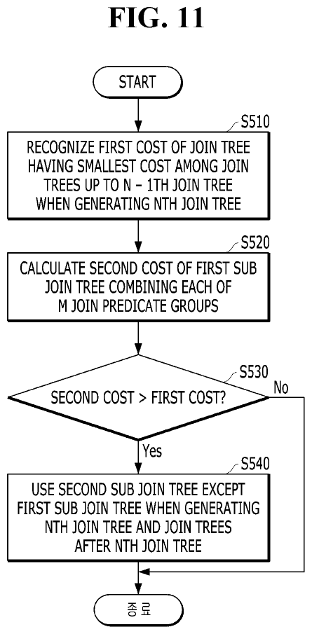

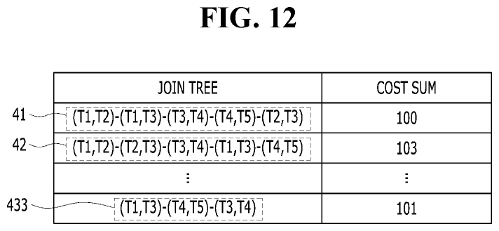

Meanwhile, when the processor 110 of the database server 100 recognizes that cost generated while at least one join tree is generated is larger than cost generated when a smallest join tree is generated, the processor 110 may stop a task of at least one join tree which is being generated. Hereinafter, a method in which the processor 110 stops generating of at least one join tree will be described below with reference to FIGS. 11 and 12.

FIG. 11 is a flowchart for describing an example of a method for generating at least one join tree by a processor according to some exemplary embodiments of the present disclosure. FIG. 12 is a table for describing an example of a method for generating at least one join tree by a processor according to some exemplary embodiments of the present disclosure.

Referring to FIG. 11, the processor 110 of the database server 100 may recognize first cost of a join tree having the smallest cost among join trees up to N−1th join trees when generating an Nth join tree (S510).

Specifically, the processor 110 may recognize the cost generated while generating each of the third join tree 41 and the fourth join tree 42 stored in the storage unit 120 while generating the fifth join tree 43 which is being generated fifth. In addition, the processor 110 may recognize the first cost of the join tree having the smallest cost.

For example, referring to FIG. 12, the processor 110 may recognize as the first cost which is the smallest “100” which is cost generated by generating the third join tree 41 while generating the fifth join tree 43. However, the present disclosure is not limited thereto.

Meanwhile, referring back to FIG. 11, the processor 110 of the database server 100 may calculate second cost of a first sub join tree combining each of M join predicate groups when generating the Nth join tree (S520).

Specifically, the processor 110 may combine each of five join predicate groups in the order like the order of the fifth join tree 43 described in FIG. 5. In this case, referring to FIG. 12, the processor 110 may generate the first sub join tree which is at least a part of the fifth join tree 43. However, the present disclosure is not limited thereto.

In addition, the processor 110 may scan and calculate the cost generated when generating the first sub join tree 433 stored in the storage unit 120. For example, the processor 110 may calculate the second cost generated when generating the first sub join tree 433 as “101”. However, the present disclosure is not limited thereto.

Meanwhile, referring back to FIG. 11, when the second cost is larger than the first cost (Yes in S530), the processor 110 of the database server 100 may use the second sub join tree except the first sub join tree 433 when generating the Nth join tree and the join trees after the Nth join tree (S540).

Specifically, the second cost of the first sub join tree 433 may be larger than the cost of the third join tree 41. In this case, even though at least one join which is not yet performed is performed in the first sub join tree 433, cost of a result of joining all tables which remain in the first sub join tree 433 cannot but be larger than the first cost of the third join tree 41.

Accordingly, the processor 110 may generate the join trees by using at least one sub join tree (i.e., second sub join tree) except the first sub join tree 433.

That is, the processor 110 may not generate a join tree in which at least one join predicate group is joined behind the first sub join tree 433.

Meanwhile, when the second cost is smaller than the first cost (No in S530), the processor 110 of the database server 100 may use the first sub join tree 433 when generating the Nth join tree and the join trees after the Nth join tree (S540).

In other words, the processor 110 may complete the fifth join tree 43 by using the first sub join tree 433. Further, the processor 110 may generate at least one join tree by using the first sub join tree 433 except the fifth join tree 43. However, the present disclosure is not limited thereto.

When the processor 110 of the database server 100 compares the smallest cost among the join trees with the cost generated while generating at least one sub join tree as described above, performing an unnecessary join operation may be skipped. Accordingly, the resource amount of the memory may be ensured and further, a speed at which the processor 110 performs the join operation may also increase.

According to some exemplary embodiments described in FIGS. 1 to 12, a processing speed of executing the join operation may be enhanced.

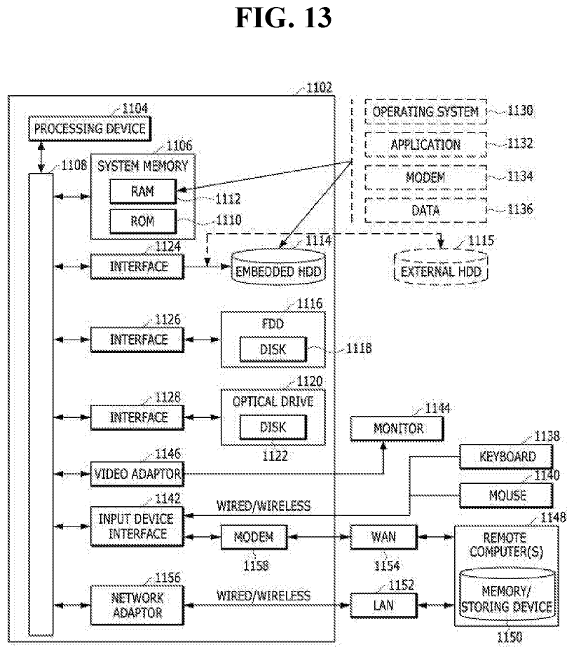

FIG. 13 is a general schematic view of an exemplary computing environment in which exemplary embodiments of the present disclosure may be implemented.

The present disclosure has generally been described above in association with a computer executable command which may be executed on one or more computers, but it will be well appreciated by those skilled in the art that the present disclosure can be implemented through a combination with other program modules and/or as a combination of hardware and software.

In general, the module in the present specification includes a routine, a procedure, a program, a component, a data structure, and the like that execute a specific task or implement a specific abstract data type. Further, it will be well appreciated by those skilled in the art that the method of the present disclosure can be implemented by other computer system configurations including a personal computer, a handheld computing device, microprocessor-based or programmable home appliances, and others (the respective devices may operate in connection with one or more associated devices as well as a single-processor or multi-processor computer system, a mini computer, and a main frame computer.

The exemplary embodiments described in the present disclosure may also be implemented in a distributed computing environment in which predetermined tasks are performed by remote processing devices connected through a communication network. In the distributed computing environment, the program module may be positioned in both local and remote memory storage devices.

The computer generally includes various computer readable media. The computer includes, as a computer accessible medium, volatile and non-volatile media, transitory and non-transitory media, and mobile and non-mobile media. As not a limit but an example, the computer readable media may include both computer readable storage media and computer readable transmission media.

The computer readable storage media include volatile and non-volatile media, temporary and non-temporary media, and movable and non-movable media implemented by a predetermined method or technology for storing information such as a computer readable instruction, a data structure, a program module, or other data. The computer readable storage media include a RAM, a ROM, an EEPROM, a flash memory or other memory technologies, a CD-ROM, a digital video disk (DVD) or other optical disk storage devices, a magnetic cassette, a magnetic tape, a magnetic disk storage device or other magnetic storage devices or predetermined other media which may be accessed by the computer or may be used to store desired information, but are not limited thereto.

The computer readable transmission media generally implement the computer readable instruction, the data structure, the program module, or other data in a carrier wave or a modulated data signal such as other transport mechanism and include all information transfer media. The term “modulated data signal” means a signal acquired by configuring or changing at least one of characteristics of the signal so as to encode information in the signal. As not a limit but an example, the computer readable transmission media include wired media such as a wired network or a direct-wired connection and wireless media such as acoustic, RF, infrared and other wireless media. A combination of any media among the aforementioned media is also included in a range of the computer readable transmission media.

An exemplary environment 1100 that implements various aspects of the present disclosure including a computer 1102 is shown and the computer 1102 includes a processing device 1104, a system memory 1106, and a system bus 1108. The system bus 1108 connects system components including the system memory 1106 (not limited thereto) to the processing device 1104. The processing device 1104 may be a predetermined processor among various commercial processors. A dual processor and other multi-processor architectures may also be used as the processing device 1104.

The system bus 1108 may be any one of several types of bus structures which may be additionally interconnected to a local bus using any one of a memory bus, a peripheral device bus, and various commercial bus architectures. The system memory 1106 includes a read only memory (ROM) 1110 and a random access memory (RAM) 1112. A basic input/output system (BIOS) is stored in the non-volatile memories 1110 including the ROM, the EPROM, the EEPROM, and the like and the BIOS includes a basic routine that assists in transmitting information among components in the computer 1102 at a time such as in-starting. The RAM 1112 may also include a high-speed RAM including a static RAM for caching data, and the like.

The computer 1102 also includes an internal hard disk drive (HDD) 1114 (for example, EIDE and SATA)—the internal hard disk drive (HDD) 1114 may also be configured for an external purpose in an appropriate chassis (not illustrated), a magnetic floppy disk drive (FDD) 1116 (for example, for reading from or writing in a mobile diskette 1118), and an optical disk drive 1120 (for example, for reading a CD-ROM disk 1122 or reading from or writing in other high-capacity optical media such as the DVD). The hard disk drive 1114, the magnetic disk drive 1116, and the optical disk drive 1120 may be connected to the system bus 1108 by a hard disk drive interface 1124, a magnetic disk drive interface 1126, and an optical drive interface 1128, respectively. An interface 1124 for implementing an external drive includes, for example, at least one of a universal serial bus (USB) and an IEEE 1394 interface technology or both of them.

The drives and the computer readable media associated therewith provide non-volatile storage of the data, the data structure, the computer executable instruction, and others. In the case of the computer 1102, the drives and the media correspond to storing of predetermined data in an appropriate digital format. In the description of the computer readable storage media, the mobile optical media such as the HDD, the mobile magnetic disk, and the CD or the DVD are mentioned, but it will be well appreciated by those skilled in the art that other types of storage media readable by the computer such as a zip drive, a magnetic cassette, a flash memory card, a cartridge, and others may also be used in an exemplary operating environment and further, the predetermined media may include computer executable instructions for executing the methods of the present disclosure.

Multiple program modules including an operating system 1130, one or more application programs 1132, other program module 1134, and program data 1136 may be stored in the drive and the RAM 1112. All or some of the operating system, the application, the module, and/or the data may also be cached by the RAM 1112. It will be well appreciated that the present disclosure may be implemented in operating systems which are commercially usable or a combination of the operating systems.

A user may input instructions and information in the computer 1102 through one or more wired/wireless input devices, for example, pointing devices such as a keyboard 1138 and a mouse 1140. Other input devices (not illustrated) may include a microphone, an IR remote controller, a joystick, a game pad, a stylus pen, a touch scene, and others. These and other input devices are often connected to the processing device 1104 through an input device interface 1142 connected to the system bus 1108, but may be connected by other interfaces including a parallel port, an IEEE 1394 serial port, a game port, a USB port, an IR interface, and others.

A monitor 1144 or other types of display devices are also connected to the system bus 1108 through interfaces such as a video adapter 1146, and the like. In addition to the monitor 1144, the computer generally includes a speaker, a printer, and other peripheral output devices (not illustrated).

The computer 1102 may operate in a networked environment by using a logical connection to one or more remote computers including remote computer(s) 1148 through wired and/or wireless communication. The remote computer(s) 1148 may be a workstation, a server computer, a router, a personal computer, a portable computer, a micro-processor based entertainment apparatus, a peer device, or other general network nodes and generally includes multiple components or all of the components described with respect to the computer 1102, but only a memory storage device 1150 is illustrated for brief description. The illustrated logical connection includes a wired/wireless connection to a local area network (LAN) 1152 and/or a larger network, for example, a wide area network (WAN) 1154. The LAN and WAN networking environments are general environments in offices and companies and facilitate an enterprise-wide computer network such as Intranet, and all of them may be connected to a worldwide computer network, for example, the Internet.

When the computer 1102 is used in the LAN networking environment, the computer 1102 is connected to a local network 1152 through a wired and/or wireless communication network interface or an adapter 1156. The adapter 1156 may facilitate the wired or wireless communication to the LAN 1152 and the LAN 1152 also includes a wireless access point installed therein in order to communicate with the wireless adapter 1156. When the computer 1102 is used in the WAN networking environment, the computer 1102 may include a modem 1158, is connected to a communication server on the WAN 1154, or has other means that configure communication through the WAN 1154 such as the Internet, etc. The modem 1158 which may be an internal or external and wired or wireless device is connected to the system bus 1108 through the serial port interface 1142. In the networked environment, the program modules described with respect to the computer 1102 or some thereof may be stored in the remote memory/storage device 1150. It will be well known that an illustrated network connection is exemplary and other means configuring a communication link among computers may be used.

The computer 1102 performs an operation of communicating with predetermined wireless devices or entities which are disposed and operated by the wireless communication, for example, the printer, a scanner, a desktop and/or a portable computer, a portable data assistant (PDA), a communication satellite, predetermined equipment or place associated with a wireless detectable tag, and a telephone. This at least includes wireless fidelity (Wi-Fi) and Bluetooth wireless technology. Accordingly, communication may be a predefined structure like the network in the related art or just ad hoc communication between at least two devices.

The wireless fidelity (Wi-Fi) enables connection to the Internet, and the like without a wired cable. The Wi-Fi is a wireless technology such as the device, for example, a cellular phone which enables the computer to transmit and receive data indoors or outdoors, that is, anywhere in a communication range of a base station. The Wi-Fi network uses a wireless technology called IEEE 802.11 (a, b, g, and others) in order to provide safe, reliable, and high-speed wireless connection. The Wi-Fi may be used to connect the computers to each other or the Internet and the wired network (using IEEE 802.3 or Ethernet). The Wi-Fi network may operate, for example, at a data rate of 11 Mbps (802.11a) or 54 Mbps (802.11b) in unlicensed 2.4 and 5 GHz wireless bands or operate in a product including both bands (dual bands).

It may be appreciated by those skilled in the art that various exemplary logical blocks, modules, processors, means, circuits, and algorithm steps described in association with the exemplary embodiments disclosed herein may be implemented by electronic hardware, various types of programs or design codes (for easy description, herein, designated as “software”), or a combination of all of them. In order to clearly describe the inter compatibility of the hardware and the software, various exemplary components, blocks, modules, circuits, and steps have been generally described above in association with functions thereof. Whether the functions are implemented as the hardware or software depends on design restrictions given to a specific application and an entire system. Those skilled in the art of the present disclosure may implement functions described by various methods with respect to each specific application, but it should not be analyzed that the implementation determination departs from the scope of the present disclosure.

Further, various exemplary embodiments presented herein may be implemented as manufactured articles using a method, an apparatus, or a standard programming and/or engineering technique. The term “manufactured article” includes computer programs or media which are accessible by a predetermined computer-readable device. For example, a computer readable medium includes a magnetic storage device (for example, a hard disk, a floppy disk, a magnetic strip, or the like), an optical disk (for example, a CD, a DVD, or the like), a smart card, and a flash memory device (for example, an EEPROM, a card, a stick, a key drive, or the like), but is not limited thereto. The term “machine-readable media” includes a wireless channel and various other media that can store, possess, and/or transfer instruction(s) and/or data, but is not limited thereto.

It will be appreciated that a specific order or a hierarchical structure of steps in the presented processes is one example of exemplary accesses. It will be appreciated that the specific order or the hierarchical structure of the steps in the processes within the scope of the present disclosure may be rearranged based on design priorities. Appended method claims provide elements of various steps in a sample order, but it does not mean that the method claims are limited to the presented specific order or hierarchical structure.

The description of the presented embodiments is provided so that those skilled in the art of the present disclosure use or implement the present disclosure. Various modifications of the exemplary embodiments will be apparent to those skilled in the art and general principles defined herein can be applied to other exemplary embodiments without departing from the scope of the present disclosure. Therefore, the present disclosure is not limited to the exemplary embodiments presented herein, but should be analyzed within the widest range which is consistent with the principles and new features presented herein.

1. A computer readable medium containing a computer program,
wherein the computer program includes commands which cause a computer to execute steps, the steps comprising:
receiving a query including a join operation;
recognizing at least one join predicate by analyzing the query;
generating at least two join predicate groups using tables associated with each of the at least one join predicate;
generating join trees by combining each of the at least two join predicate groups in a different order;
calculating a cost of each of the join trees; and
recognizing a join tree having the smallest cost among the join trees.

2. The computer readable medium of claim 1, wherein the generating at least two join predicate groups using tables associated with each of the at least one join predicate comprises:
if the at least one join predicate includes a first join predicate and a second join predicate, generating a first join predicate group using a first table group associated with the first join predicate, and generating a second join predicate group using a second table group associated with the second join predicate.

3. The computer readable medium of claim 2, wherein the generating join trees by combining each of the at least two join predicate groups in a different order comprises:
joining each of the first table group to generate a first subtree, and then joining each of the second table group to generate a second subtree; and
joining the first subtree to the second subtree to generate a first join tree.

4. The computer readable medium of claim 2, wherein the generating join trees by combining each of the at least two join predicate groups in a different order comprises:
joining each of the second table group to generate a second subtree before joining each of the first table group to generate a first subtree; and
joining the each of the first table group to the second subtree to generate a second join tree.

5. The computer readable medium of claim 3, wherein the generating join trees by combining each of the at least two join predicate groups in a different order further comprises:
recognizing cardinality values of each of the first join predicate group and the second join predicate group using a first value which is multiplied by a number of rows of the each of the first table group, a second value which is multiplied by a number of rows of the each of the second table group, a first join selectivity associated with the first table group, and a second join selectivity associated with the second table group; and
determining a subtree to be generated first among the first subtree and the second subtree according to a first cardinality value of the first join predicate group and a second cardinality value of the second join predicate group.

6. The computer readable medium of claim 5, wherein the determining a subtree to be generated first among the first subtree and the second subtree comprises:
if the first cardinality is lower than the second cardinality, determining the first subtree as the subtree to be generated first; and
if the first subtree is determined as the subtree to be generated first, generating the first subtree before generating the second subtree.

7. The computer readable medium of claim 5, wherein the determining a subtree to be generated first among the first subtree and the second subtree comprises:
if the first cardinality is higher than the second cardinality, determining the second subtree as the subtree to be generated first; and
if the second subtree is determined as the subtree to be generated first, generating the second subtree before generating the first subtree.

8. The computer readable medium of claim 3, wherein the generating join trees by combining each of the at least two join predicate groups in a different order further comprises:
determining a priority of each of the first join predicate and a third join predicate; and
determining a subtree to be generated first among the first subtree and a third subtree according to a first priority of the first join predicate and a second priority of the second join predicate.

9. The computer readable medium of claim 8, wherein the determining a subtree to be generated first among the first subtree and a third subtree comprises:
if the first priority is lower than the second priority, determining the third subtree as the subtree to be generated first.

10. The computer readable medium of claim 8, wherein the determining a subtree to be generated first among the first subtree and a third subtree comprises:
if the first priority is higher than the second priority, determining the first subtree as the subtree to be generated first.

11. The computer readable medium of claim 1, wherein the generating join trees by combining each of the at least two join predicate groups in a different order comprises:
when generating an Nth join tree, recognizing a first cost of a join tree having the smallest cost among join trees up to an N−1th join tree;
calculating a second cost of a first sub join tree combining each of M(M is a natural number) join predicate groups; and
if the second cost is bigger than the first cost, using a second sub join tree except the first sub join tree when generating the Nth join tree and a join tree after the Nth join tree.

12. The computer readable medium of claim 1, wherein the generating join trees by combining each of the at least two join predicate groups in a different order further comprises:
checking joined tables and non-joined tables;
if at least one table included in the non-joined tables exists among the joined tables, checking a first time point at which the at least one table is joined; and
recognizing that the at least one table is joined at the first time point.

13. A database server, comprising
a communication unit receiving a query including a join operation; and
a processor recognizing at least one join predicate by analyzing the query;
wherein the processor is further configured to:
generate at least two join predicate groups using tables associated with each of the at least one join predicate,
generate join trees by combining each of the at least two join predicate groups in a different order,
calculate a cost of each of the join trees, and
recognize a join tree having the smallest cost among the join trees.

14. The server of claim 13, wherein the processor is further configured to:
if the at least one join predicate includes a first join predicate and a second join predicate, generate a first join predicate group using a first table group associated with the first join predicate, and generate a second join predicate group using a second table group associated with the second join predicate,
join each of the first table group to generate a first subtree, and then join each of the second table group to generate a second subtree, and
join the first subtree to the second subtree to generate a first join tree.

15. (canceled)

16. (canceled)

17. (canceled)

18. (canceled)

19. (canceled)

20. The computer readable medium of claim 4, wherein the generating join trees by combining each of the at least two join predicate groups in a different order further comprises:
recognizing cardinality values of each of the first join predicate group and the second join predicate group using a first value which is multiplied by a number of rows of the each of the first table group, a second value which is multiplied by a number of rows of the each of the second table group, a first join selectivity associated with the first table group, and a second join selectivity associated with the second table group; and
determining a subtree to be generated first among the first subtree and the second subtree according to a first cardinality value of the first join predicate group and a second cardinality value of the second join predicate group.

21. The computer readable medium of claim 20, wherein the determining a subtree to be generated first among the first subtree and the second subtree comprises:
if the first cardinality is lower than the second cardinality, determining the first subtree as the subtree to be generated first; and
if the first subtree is determined as the subtree to be generated first, generating the first subtree before generating the second subtree.

22. The computer readable medium of claim 20, wherein the determining a subtree to be generated first among the first subtree and the second subtree comprises:
if the first cardinality is higher than the second cardinality, determining the second subtree as the subtree to be generated first; and
if the second subtree is determined as the subtree to be generated first, generating the second subtree before generating the first subtree.

23. The computer readable medium of claim 4, wherein the generating join trees by combining each of the at least two join predicate groups in a different order further comprises:
determining a priority of each of the first join predicate and a third join predicate; and
determining a subtree to be generated first among the first subtree and a third subtree according to a first priority of the first join predicate and a second priority of the second join predicate.

24. The computer readable medium of claim 23, wherein the determining a subtree to be generated first among the first subtree and a third subtree comprises:
if the first priority is lower than the second priority, determining the third subtree as the subtree to be generated first.

25. The computer readable medium of claim 23, wherein the determining a subtree to be generated first among the first subtree and a third subtree comprises:
if the first priority is higher than the second priority, determining the first subtree as the subtree to be generated first.
